(19) United States
(12) Patent Application Publication
(10) Pub. No.: US 2013/0114280 A1
(43) Pub. Date: May 9, 2013

(54) VEHICLE LAMP STRUCTURE

(71) Applicant: Se Wook OH, Gunpo-si (KR)

(72) Inventor: Se Wook OH, Gunpo-si (KR)

(73) Assignees: Kia Motors Corporation, Seoul (KR); Hyundai Motor Company, Seoul (KR)

(21) Appl. No.: 13/529,567

(22) Filed: Jun. 21, 2012

(30) Foreign Application Priority Data
Nov. 9, 2011 (KR) 10-2011-0116608

(51) Int. Cl. B60Q 1/30; F21V 5/04; F21V 7/00

(52) U.S. Cl. 362/516

(57) ABSTRACT

A vehicle lamp structure may include a lamp housing having a first reflector formed on a rear inner surface thereof and a first lens formed on a front surface thereof, a second reflector provided inside the lamp housing and having a plurality of curved surfaces formed thereon, a plurality of first light sources formed on the curved surfaces of the second reflector to emit light toward the first lens, a second lens accommodating the second reflector and the first light sources therein, and a second light source mounted on a rear surface of the second lens to emit light toward the first reflector.

### CROSS-REFERENCE TO RELATED APPLICATION

The present application claims priority to Korean Patent Application No. 10-2011-0116608, filed on Nov. 9, 2011 in the Korean Intellectual Property Office, the entire contents of which is incorporated herein for all purposes by this reference.

### BACKGROUND OF THE INVENTION

1. Field of the Invention

The present invention relates to a vehicle lamp structure, and more particularly to a vehicle lamp structure that can implement constant surface light emission through application of a minimum number of light sources to the vehicle lamp structure.

2. Description of Related Art

In general, rear lamps are detachably mounted in the rear of a vehicle body, and enable drivers of front and rear vehicles to recognize the driving situation of the vehicle, to prevent a rear-end collision or the like.

In particular, the rear lamp mounted on the left or right side in the rear of the vehicle body is composed of one assembly in which a backup lamp, a brake lamp, and a direction indicator lamp are assembled together.

On the other hand, as the vehicle rear lamp, an LED (Light Emitting Diode), which has a long lifespan, expresses a high-quality image to outside, and has a superior visibility, has been increasingly used.

However, in the related art, since plural LEDs are applied according to a designed shape of the rear lamp, the manufacturing cost is increased. Further, since a reflector is additionally provided to reflect light emitted through the plural LEDs in a lamp housing at various angles, the manufacturing cost is increased, and the number of components is increased to deteriorate the workability.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a vehicle lamp structure which can implement constant surface light emission through application of a minimum number of light sources to the vehicle lamp structure.

In one aspect of the present invention, a vehicle lamp structure may include a lamp housing having a first reflector formed on a rear inner surface thereof and a first lens formed on a front surface thereof, a second reflector provided inside the lamp housing and having a plurality of curved surfaces formed thereon, a plurality of first light sources formed on the curved surfaces of the second reflector to emit light toward the first lens, a second lens accommodating the second reflector and the first light sources therein, and a second light source mounted on a rear surface of the second lens to emit light toward the first reflector.

Each of the first light sources is formed on the individual curved surfaces of the second reflector.

The vehicle lamp structure may further include sub-lenses additionally provided on upper and lower sides of the second lens.

The sub-lenses may surround the second lens in the first reflector.

The sub-lens is provided in a state where a rear surface of the sub-lens is opened.

The first light source and the second light source may include LEDs (Light emitting Diodes).

As described above, according to the present invention, the number of light sources and reflectors can be minimized to reduce the manufacturing cost, and higher surface light emission can be achieved only with the minimum number of light sources to improve the merchantability.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a vehicle lamp structure according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, a preferred embodiment of the present invention will be described with reference to the accompanying drawing.

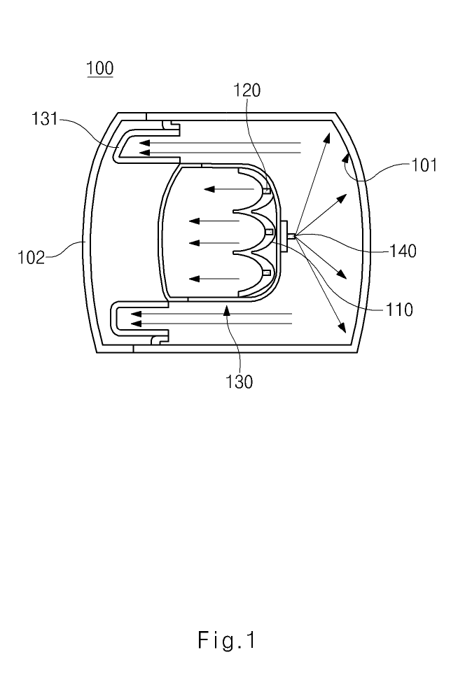

As illustrated in FIG. 1, a vehicle lamp structure according to an exemplary embodiment of the present invention includes a lamp housing 100 in which a first reflector 101 and a first lens 102 are formed, a second reflector 110 provided inside the lamp housing 100, first light sources 120 formed on the second reflector 110, a second lens 130 in which the second reflector 110 and the first light sources 120 are provided, and a second light source 140 mounted on a rear surface of the second lens 130 The number of the light sources and the reflectors is minimized to reduce the manufacturing cost, and the surface light-emitting performance of the lamp is improved.

Respective constituent elements of a vehicle lamp structure according to an exemplary embodiment of the present invention will now be described in detail with reference to the accompanying drawing.

First, as illustrated in FIG. 1, the vehicle lamp structure according to an exemplary embodiment of the present invention basically includes a lamp housing 100 accommodating a first reflector 101 and a first lens 102 therein, a second reflector 110 and first light sources 120 provided inside the lamp housing 100, a second lens 130 accommodating the second reflector 110 and the first light sources 120 therein, and a second light source 140 provided on the rear surface of the second lens 130.

The lamp housing 100 is in the form of a housing that constitutes a vehicle lamp.

The first reflector 101 that reflects light is formed on the inner surface of the lamp housing 100, and the first lens 102 for irradiating the reflected light to the outside is formed on the front surface of the lamp housing 100.

The second reflector 110 is provided inside the lamp housing 100. The second reflector 110 has a plurality of curved surfaces formed thereon, and enables the light emitted from the first light sources 120 to be described hereinafter to be refracted and reflected through the curved surfaces formed on the second reflector 110.

The first light sources 120 are installed on the inner curved surfaces of the second reflector 110.

In this case, since the plurality of first light sources 120 are provided on the plurality of curved surfaces formed on the second reflector 110, the light-emitting performance can be improved.

The second lens 130 accommodates the second reflector 110 and the first light sources 120 therein. The second lens 130 is in the form of a closed spherical surface, and accommodates the second reflector 110 and the first light source 120, so that the light emitted from the first light sources 120 is reflected by the second reflector 110 and then is irradiated to the outside of the second lens 130.

The second light source 140 is mounted on the rear surface of the second lens 130 and reflects the light through the first reflector 101 in the lamp housing 100 to perform light emission separately from the first light sources 120.

Here, it is preferable that the first light source 120 and the second light source 140 include LEDs (Light Emitting Diodes).

It is preferable that sub-lenses 131 are additionally provided on an upper side and a lower side of the second lens 130 In this case, the light emitted from the second light source 140, which has been reflected by the first reflector 101, is irradiated to the outside through the sub-lenses 131 before the light passes through the first lens 102, and thus the light-emitting effect, which is different from the light-emitting effect of the light that is irradiated through the first light sources 120, can be obtained.

In an exemplary embodiment of the present invention, the sub-lens 131 may surround the second lens 130 in the first reflector 101.

On the other hand, it is preferable that the rear surface of the sub-lens 131 is in an open state, and thus the light emitted from the second light source 140 is reflected by the first reflector 101 and then is incident to the sub-lens 131.

As described above, according to an exemplary embodiment of the present invention, since the second reflector 110 is extended as a light-emitting surface in the form of a curved surface and the first light sources 120 are installed on the second reflector 110, a better surface light-emitting effect can be obtained in comparison to a case where a plurality of light sources are installed in a circular shape Further, since the second light source 140 is additionally provided on the rear surface of the second lens 130, the light, which is emitted and reflected by the second light source 140 and the first reflector 101, respectively, is irradiated to the outside through the sub-lenses 131 and the first lenses 102, and thus the light-emitting design of the lamp can be improved.

As described above, according to an exemplary embodiment of the present invention, since the vehicle lamp structure includes the lamp housing having the first reflector formed on then inner surface thereof and the first lens formed on the front surface thereof, the second reflector provided inside the lamp housing and having the plurality of curved surfaces formed thereon, the plurality of first light sources formed on the curved surfaces of the second reflector, the second lens accommodating the second reflector and the first light sources therein, and the second light source mounted on the rear surface of the second lens, the number of light sources and reflectors can be minimized to reduce the manufacturing cost, and higher surface light emission can be achieved only with the minimum number of light sources to improve the merchantability.

Although a preferred embodiment of the present invention has been described for illustrative purposes, those skilled in the art will appreciate that various modifications, additions and substitutions are possible, without departing from the scope and spirit of the invention as disclosed in the accompanying claims.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle lamp structure comprising:
a lamp housing having a first reflector formed on a rear inner surface thereof and a first lens formed on a front surface thereof;
a second reflector provided inside the lamp housing and having a plurality of curved surfaces formed thereon;
a plurality of first light sources formed on the curved surfaces of the second reflector to emit light toward the first lens;
a second lens accommodating the second reflector and the first light sources therein; and
a second light source mounted on a rear surface of the second lens to emit light toward the first reflector.

2. The vehicle lamp structure according to claim 1, wherein each of the first light sources is formed on the individual curved surfaces of the second reflector.

3. The vehicle lamp structure according to claim 1, further comprising sub-lenses additionally provided on upper and lower sides of the second lens.

4. The vehicle lamp structure according to claim 3, wherein the sub-lenses surround the second lens in the first reflector.

5. The vehicle lamp structure according to claim 3, wherein the sub-lens is provided in a state where a rear surface of the sub-lens is opened.

6. The vehicle lamp structure according to claim 1, wherein the first light source and the second light source include LEDs (Light emitting Diodes).
